(19) United States
(12) Patent Application Publication
(10) Pub. No.: US 2014/0295206 A1
(43) Pub. Date: Oct. 2, 2014

(54) SUBSTRATE FOR PHOTOSENSITIVE DRUM

(71) Applicants: Shigeru Aoya, Oyama-shi (JP); Masaaki Oide, Utsunomiya-shi (JP)

(72) Inventors: Shigeru Aoya, Oyama-shi (JP); Masaaki Oide, Utsunomiya-shi (JP)

(73) Assignee: SHOWA DENKO K.K., Minato-ku, Tokyo (JP)

(21) Appl. No.: 14/238,879

(22) PCT Filed: Aug. 13, 2012
(86) PCT No.: PCT/JP2012/070589

§ 371 Date: Jun. 6, 2014

(30) Foreign Application Priority Data
Aug. 19, 2011 (JP) 2011-179867

(51) Int. Cl. G03G 5/10; B21C 23/21

(52) U.S. Cl. CPC G03G 5/102; B21C 23/217
USPC 428/600; 72/264

(57) ABSTRACT

A substrate 41 for a photosensitive drum is formed from an uncut metal tube. In an observation visual field 52 in which an image forming surface 41aa of a surface 41a of the substrate 41 is observed in a visual field having an arbitrary size, a total occupancy area ratio of pits having an area ratio of 1 μm² or more with respect to the observation visual field area is 2% or more, and the average area per pit having an area of 1 μm² or more is greater than 8 μm².

### TECHNICAL FIELD

The present invention relates to a substrate for a photosensitive drum for use in, for example, an electrophotoraphic device (e.g., a copying machine, a printer, a facsimile device, etc.), and also relates to a production method of a substrate for a photosensitive drum.

In the present specification and claims, the language of “aluminum” is used to include the meaning of both pure aluminum and aluminum alloys, unless otherwise specifically described. Also, the language of “upstream” and “downstream” mean upstream and downstream with respect to a drawing direction of a metal tube.

### TECHNICAL BACKGROUND

For a substrate used for a photosensitive drum for use in an electrophotographic device, such as, e.g., a copying machine, a printer, a facsimile device, etc., generally, an OPC (organic photoconductor) layer is applied evenly in thickness to the outer surface thereof as an organic photoreceptor layer. In a currently mainstream separated-function type organic photoreceptor, a charge generating layer (CGL) and a charge transporting layer (CTL) are laminated in this order on an outer surface of the substrate.

In an aluminum tube used for the substrate, since it is required to form a photoreceptor layer uniform in thickness on the outer surface thereof, it is generally required that the outer surface is in a near-mirror finished surface state.

Conventionally, an outer surface of an aluminum tube was subjected to cutting to perform a mirror finish process on the outer surface. However, since adjustment and management of the cutting tool were not easy and the operation required skills, there was a problem that it was not suitable for mass production. A tube obtained by subjecting the outer surface to cutting as mentioned above is called a cut tube.

Under the circumstances, in recent years, an uncut tube, which is not a cut tube that the outer surface thereof is required to be subjected to cutting but a tube that the outer surface thereof is not required to be subjected to cutting, has become more popularly used for a substrate for a photosensitive drum. As such an uncut tube, there are, for example, a tube obtained by subjecting a rolled aluminum sheet to ironing (“Rolling-Ironing tube”), a tube obtained by subjecting an aluminum extruded tube to ironing (“Extrusion-Ironing tube”), and a tube obtained by subjecting an aluminum extruded tube to drawing (“Extrusion-Drawing tube”). Among them, an Extrusion-Drawing tube is different from other uncut tubes in that it is possible to produce more than ten tubes in a single process, which is suitable for mass production. Therefore, it has been receiving attention as a product capable of and compatible with mass consumption due to market expansion.

A method of producing a substrate for a photosensitive drum from an Extrusion-Drawing tube is as follows, for example. An Extrusion-Drawing tube is manufactured by obtaining an aluminum extruded tube by extruding an aluminum billet, cutting the extruded tube into a predetermined length, and then drawing the cut tube to obtain an aluminum tube having an outer diameter, an inner diameter, and a thickness each regulated to respective values. Then, the Extrusion-Drawing tube is subjected to cutting, chamfering of the cut edge portions, and cleaning in order, followed by inspection of the dimension and appearance, to thereby obtain a substrate for a photosensitive drum.

The aforementioned substrate for a photosensitive drum is required to have high surface smoothness and dimensional accuracy. However, an Extrusion-Drawing tube has many variation factors, such as, e.g., the components of the billet, the outer diameter, the thickness, the hardness, the surface roughness, and the surface contamination of the extruded tube. Therefore, in cases where a substrate for a photosensitive drum is produced from an Extrusion-Drawing tube, it is not easy to improve the surface smoothness and the dimensional accuracy. Since the Extrusion-Drawing tube is an uncut tube, on the outer surface of the substrate formed from an Extrusion-Drawing tube, there sometimes are stripe-shaped defects due to die lines generated during the extrusion process or minute concave portions, such as, e.g., oil pits, etc., due to drawn lubricating oil during the drawing process.

Japanese Unexamined Laid-opened Patent Application Publication No. H08-272119 (Patent Document 1) discloses to control the surface roughness of the outer surface of the tube to be subjected to a drawing process in the circumferential direction thereof so as to fall within a predetermined range to prevent generation of stripe-shaped defects. With the method disclosed in this publication, however, it was difficult to prevent generation of oil pits. Therefore, when the thickness of the charge generating layer to be coated on the outer surface of the substrate is comparatively thin, such as, e.g., less than 0.2 μm, the image quality may become low in some cases.

Japanese Unexamined Laid-opened Patent Application Publication No. H09-99313 (Patent Document 2) discloses that the first pass of the drawing process is a skin pass in which the reduction amount of the outer diameter is 6 mm or less to prevent generation of stripe-shaped defects. However, with the method disclosed in this publication, the alignment effect during the drawing process is lost by reducing the reduction amount of the outer diameter of the tube, and as a result, there was a drawback that the distribution of oil pits became uneven in the circumferential direction of the tube.

A method for controlling generation of oil pits to be generated on a surface of a rolled aluminum sheet, although the method is not directed to a substrate for a photosensitive drum, is disclosed in Japanese Unexamined Laid-opened Patent Application Publication No. H10-296307 (Patent Document 3). Furthermore, a method for equalizing distribution of oil pits to be generated on a surface of a copper alloy foil, although the method is not directed to a substrate for a photosensitive drum, is disclosed in Japanese Unexamined Laid-opened Patent Application Publication No. 2007-268596 (Patent Document 4).

Further, Japanese Unexamined Laid-opened Patent Application Publication No. 2010-46690 (Patent Document 5), Japanese Unexamined Laid-opened Patent Application Publication No. 2010-52018 (Patent Document 6) and Japanese Unexamined Laid-opened Patent Application Publication No. 2010-194598 (Patent Document 7) disclose drawing process methods for tube-shaped works capable of obtaining a drawn tube having a highly smooth outer surface.

On the other hand, when a surface condition of an outer surface of a substrate becomes too close to a mirror-surface, interference patterns are generated due to multiple reflection of a laser beam as light generated from an exposure source on an interface in a photoreceptor layer and/or an outer surface of the substrate. As a result, it sometimes adversely affects image quality. To prevent such generation of interference patterns due to such multiple reflection, the outer surface of the substrate is roughened in some cases. For example, Japanese Unexamined Laid-opened Patent Application Publication No. 2005-234034 (Patent Document 8) discloses that an outer surface of a substrate is roughened by a liquid honing process to prevent generation of interference patterns. Furthermore, this publication discloses that the surface roughness of the outer surface of the substrate required for preventing generation of interference patterns is about Rz 0.6 μm or more which differs depending on shape.

### PRIOR ART DOCUMENTS

### Patent Document

Patent Document 1: Japanese Unexamined Laid-opened Patent Application Publication No. H08-272119
Patent Document 2: Japanese Unexamined Laid-opened Patent Application Publication No. H09-99313
Patent Document 3: Japanese Unexamined Laid-opened Patent Application Publication No. H10-296307
Patent Document 4: Japanese Unexamined Laid-opened Patent Application Publication No. 2007-268596
Patent Document 5: Japanese Unexamined Laid-opened Patent Application Publication No. 2010-46690
Patent Document 6: Japanese Unexamined Laid-opened Patent Application Publication No. 2010-52018
Patent Document 7: Japanese Unexamined Laid-opened Patent Application Publication No. 2010-194598
Patent Document 8: Japanese Unexamined Laid-opened Patent Application Publication No. 2005-234034 (see paragraph (0004))

### DISCLOSURE OF THE INVENTION

### Problems to be Solved by the Invention

In recent years, developments of electrophotographic devices have being advanced, and it is desired to thinly and evenly form a photoreceptor layer on an outer surface of a substrate to attain even better image quality and faster printing. Especially in cases where a photoreceptor layer is a separated-function type organic photoreceptor layer, it is required to form a charge generating layer thinly and evenly. In order to stably, thinly and evenly form the charge generating layer, it is generally said that the image forming surface on the outer surface of the substrate is required to be in a mirror-state having a surface roughness of Ry 1.0 μm or less.

In cases where a substrate is produced from a cut tube, it is indeed that a high-quality image can be obtained by setting the image forming surface of the substrate to a surface roughness of Ry 1.0 μm or less. On the other hand, in cases where a substrate is produced from an uncut tube, even if the image forming surface of the substrate is set to a surface roughness of Ry 1.0 μm or less, in some cases, a high-quality image could not be obtained due to, e.g., generation of interference patterns caused by multiple reflection of a laser beam. To the contrary, even if the image forming surface of the substrate has a surface roughness exceeding Ry 1.0 μm, in some cases, a high-quality image could be obtained. Under the circumstances, the present inventors have investigated the causes and found the following findings.

Generally, a surface roughness of an image forming surface of a substrate is measured by a stylus-type surface roughness tester using a probe having a tip radius R of 5 μm compliant with JIS (Japanese Industrial Standard). In cases where a substrate is produced from a cut tube, since the image forming surface of the substrate is in a regular surface configuration obtained by a cutting process with a cutting tool, the value of the surface roughness Ry of the image forming surface is approximately constant regardless of the measured point by the stylus-type surface roughness tester. Therefore, in cases where the substrate is produced from a cut tube, the surface roughness Ry measured by a stylus-type surface roughness tester can be used as an index for judging the image quality.

On the other hand, in cases where a substrate is produced from an uncut tube instead of a cut tube, as shown in FIG. 6, the image forming surface of the substrate is in a comparatively irregular surface configuration formed by a drawing process, etc. Therefore, the surface roughness Ry of the image forming surface is largely different in value depending on the measured points A, B by the stylus-type surface roughness tester. For example, the surface roughness Ry measured at a measurement point A is larger than the surface roughness Ry measured at a measurement point B. Furthermore, when measuring the surface roughness with a stylus-type surface roughness tester, there also is a drawback that the measurement accuracy is poor at portions where the tip of the probe is unable to enter. Therefore, in cases where a substrate is produced from an uncut tube, it is inappropriate to use the surface roughness Ry measured by the stylus-style surface roughness tester as an index for judging the image quality.

The present inventors could have obtained the aforementioned knowledge.

The present invention was made in view of the aforementioned technical background, and aims to provide a substrate for a photosensitive drum capable of obtaining a high-quality image by providing a new index for determining an image quality for a substrate for a photosensitive drum produced from an uncut metal tube, and also to provide a photosensitive drum using the substrate and a production method of the substrate.

The other purposes and advantages of the present invention will be apparent from the preferred embodiments described below.

### Means for Solving the Problems

The present invention provides the following means.

[1] A substrate for a photosensitive drum formed from an uncut metal tube,

wherein, in an observation visual field in which an image forming surface is observed in a visual field having an arbitrary size, a total occupancy area ratio of pits having an area of 1 μm² or more with respect to an area of the observation visual field is 2% or more, and an average area per pit having an area of 1 μm² or more is greater than 8 μm².

[2] The substrate for a photosensitive drum as recited in the aforementioned Item 1, wherein, in the observation visual field,

the total occupancy area ratio of pits having an area of 1 μm² or more with respect to the area of the observation visual field is 15% or less,

the average area per pit having an area of 1 μm² or more is 20 μm² or less, and

no large pits having an area of 300 μm² or more exist.

[3] The substrate for a photosensitive drum as recited in the aforementioned Item 1 or 2, wherein the substrate is made of aluminum.

[4] A production method of the substrate for a photosensitive drum as recited in any one of the aforementioned Items 1 to 3, the method comprising:

a drawing process step of obtaining an uncut metal tube by subjecting an extruded metal tube to a drawing process using a drawing device equipped with a drawing die for processing an outer surface of the extruded metal tube and a drawing plug for processing an inner surface of the extruded metal tube,

wherein the drawing die includes

a first curved surface portion from which the extruded metal tube separates while being subjected to a diameter reducing process,

a die bearing portion arranged radially inward of and downstream of an extruded metal tube separating position of the first curved surface portion, and

a guiding portion having a second curved surface portion smoothly continued to an upstream end of the die bearing portion, the guiding portion being configured to guide the extruded metal tube to the die bearing portion while subjecting the extruded metal tube to a diameter reducing process by coming into re-contact with the extruded metal tube separated from the first curved surface portion, and

wherein the drawing plug is equipped with a plug bearing portion shorter than a length of the die bearing portion.

### Effects of the Invention

The present invention exerts the following effects.

In the substrate of the aforementioned Item [1], in an observation visual field of the image forming surface thereof, a total occupancy area ratio of pits having an area of 1 μm² or more with respect to an area of the observation visual field is 2% or more, and an average area per pit having an area of 1 μm² or more is greater than 8 μm². By producing a photosensitive drum using such a substrate, generation of interference patterns caused by multiple reflection of light emitted from an exposure source (example: laser beam) can be prevented, and thus, a high-quality image can be obtained.

In the substrate of the aforementioned Item [2], in the observation visual field of the image forming surface of the substrate, the total occupancy area ratio of pits having an area of 1 μm² or more with respect to the area of the observation visual field is 15% or less, the average area per pit having an area of 1 μm² or more is 20 μm² or less, and no large pits having an area of 300 μm² or more exist. By producing a photosensitive drum using such a substrate, dark spots can be prevented from being generated on a printing surface. As a result, a high-quality image can be assuredly obtained.

Since the substrate of the aforementioned Item [3] is made of aluminum, the photosensitive drum can be made light, thereby reducing the driving force required for rotating the photosensitive drum.

In the production method of the substrate for a photosensitive drum of the aforementioned Item [4], since the extruded metal tube is subjected to a drawing process using a predetermined drawing device, the following effects can be exerted.

In the drawing process, the extruded metal tube separates from the first curved surface portion so as to be guided toward the guiding portion while being subjected to a diameter reducing process by the first curved surface portion of the drawing die of the drawing device. Also, the tube is guided to the die bearing portion from the guiding portion while the tube comes into re-contact with the guiding portion and is subjected to a diameter reducing process by the guiding portion. Thus, the tube passes through between the die bearing portion and the plug bearing portion.

In the aforementioned material flow of the extruded metal tube, since the die bearing portion is arranged radially inward than the extruded metal tube separating position of the first curved surface portion, the tube can be prevented from being excessively reduced in diameter while the tube moves from the first curved surface portion to the die bearing portion.

Furthermore, because the second curved surface portion of the guiding portion is smoothly continued to the upstream end of the die bearing portion, the tube that comes into contact again with the guiding portion can smoothly move toward the die bearing portion via the second curved surface portion.

Furthermore, by setting the length of the plug bearing portion of the drawing plug to be shorter than the length of the die bearing portion of the drawing die, a pressure required to form the outer surface of the extruded metal tube into a moderately high smooth surface can be applied from both the plug bearing portion and the die bearing portion.

With synergistically exerting the aforementioned effects, the outer surface of the extruded metal tube can be assuredly formed into a moderate high smooth surface. Therefore, a substrate as described in any one of the aforementioned Items [1] to [3] can be produced at a high yield rate.

### BRIEF DESCRIPTION OF THE DRAWINGS

FIG. 1 is a schematic perspective view showing a substrate for a photosensitive drum according to an embodiment of the present invention and an image analysis device.

FIG. 2 is an enlarged cross-sectional view showing a surface of the photosensitive drum using the substrate.

FIG. 3 is an enlarged cross-sectional view showing a surface of a photosensitive drum according to another embodiment using the substrate.

FIG. 4A is a schematic entire view showing a drawing device used for producing a substrate for a photosensitive drum according to an embodiment of the present invention.

FIG. 4B is a cross-sectional view showing a drawing die and a drawing plug in the middle of drawing an extruded aluminum tube using the drawing device.

FIG. 4C is an enlarged view of FIG. 4B.

FIG. 5A is cross-sectional view showing a drawing die and a drawing plug of a drawing device used in a comparative example.

FIG. 5B is an enlarged view of FIG. 5A.

FIG. 6 shows an image (top) of an image forming surface on an outer surface of a substrate taken by a digital microscope and an image (bottom) in which the aforementioned image is binarized by an image analysis device.

### EMBODIMENTS FOR CARRYING OUT THE INVENTION

Next, an embodiment of the present invention will be explained with reference to the attached drawings.

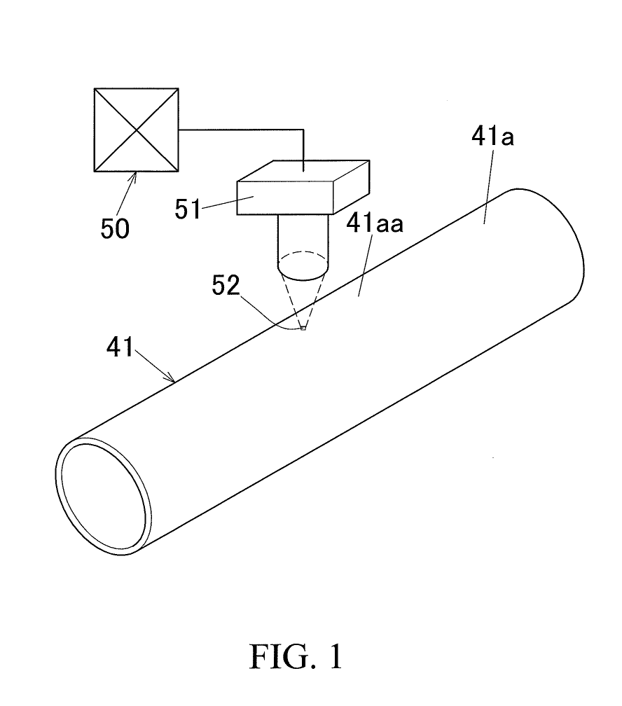

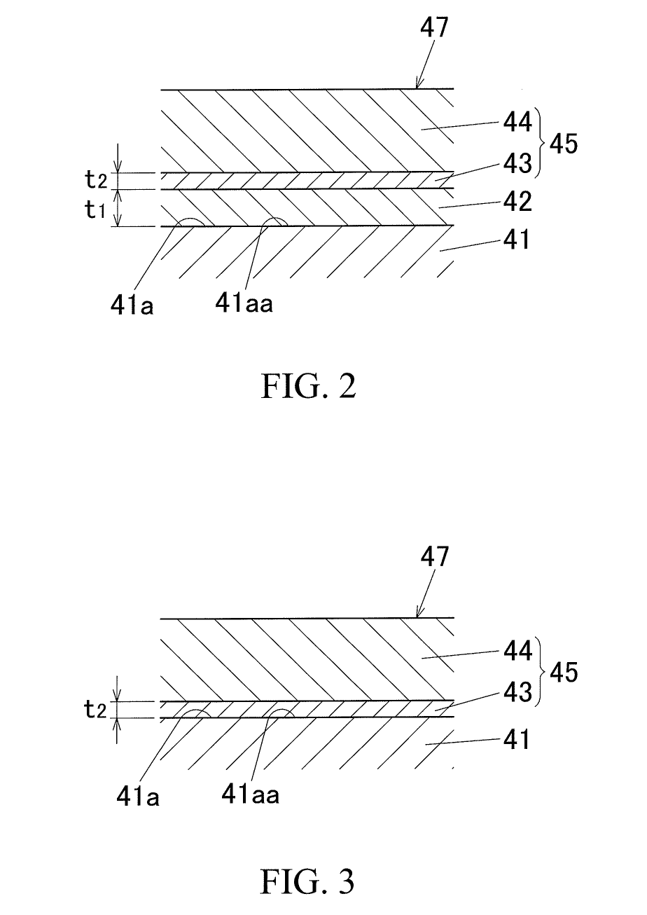

In FIG. 1, “41” denotes a substrate for a photosensitive drum according to an embodiment of the present invention. As shown in FIG. 2, in the photosensitive drum 47, a separated-function type organic photoreceptor layer 45 as a laminated type photoreceptor layer is coated on an image forming surface 41aa of the outer surface 41a of the substrate 41 via an undercoat layer (undercoating layer, UCL) 42 along the entire periphery thereof in the circumferential direction. That is, the undercoat layer 42 is arranged between the image forming surface 41aa of the substrate 41 and the photoreceptor layer 45. The photoreceptor layer 45 is constituted by a charge generating layer (CGL) 43 formed on the undercoat layer 42 and a charge transporting layer (CTL) 44 formed on the charge generating layer 43.

The regions of the outer surface 41a of the substrate 41 in the vicinity of both ends thereof generally do not constitute an image forming surface 41aa since the regions do not contribute to image forming. That is, in this specification and claims, the image forming surface 41aa of the substrate 41 refers to the axially central region on the outer surface 41a of the substrate 41, excluding the regions in the vicinity of both ends that do not contribute to image forming.

The photosensitive drum 47 is used in an electrophotographic device, such as, a copying machine, a laser beam printer, a facsimile machine, etc.

The substrate 41 is formed from an uncut metal tube, more specifically, an uncut aluminum tube. In this embodiment, the uncut aluminum tube is a tube obtained by subjecting an extruded aluminum tube 40 as an extruded metal tube to a drawing process, more specifically an aluminum Extrusion-Drawing tube. The cross-sectional shape thereof is annular.

The material of the substrate 41 is an Al—Mn series alloy, an Al—Mg series alloy, an Al—Mg—Si series alloy, a pure Al, etc. When the substrate 41 is made of aluminum as mentioned above, the photosensitive drum 47 can be made light, thereby making it possible to reduce the driving force required to rotate the photosensitive drum 47.

The length, diameter (outer diameter) and thickness of the substrate 41 are not limited, but can be specifically exemplified as 200 to 400 mm in length, 15 to 50 mm in outer diameter, and 0.5 to 2 mm in thickness.

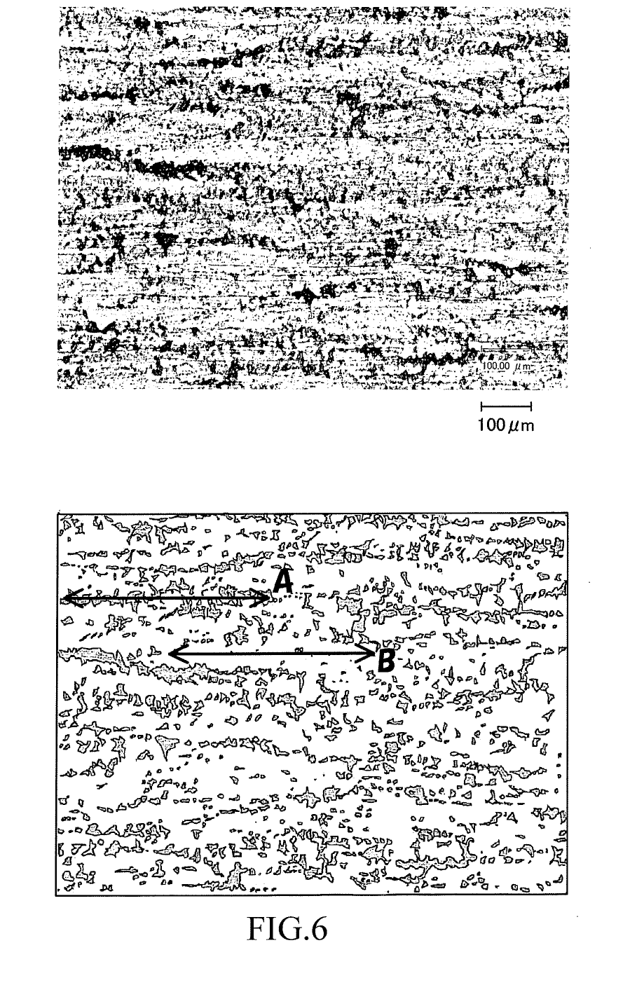

Since the substrate 41 is formed from an Extrusion-Drawing tube as described above, a plurality of oil pits, which are a kind of minute concave portions, are formed on the image forming surface 41aa of the substrate 41 as shown in FIG. 6. The oil pit is a minute concave portion caused by forced-in lubricating oil for a drawing process. In detail, the oil pit is a minute concave portion formed on the outer surface of the tube when the lubricating oil entered in between the outer surface of the tube and the drawing die during the drawing process is forced into the outer surface of the tube. Furthermore, in some cases, minute concave portions other than the oil pits may be formed on the image forming surface 41aa. Therefore, in this specification and claims, the oil pit and the minute concave portion different from the oil pit are collectively referred to as a “pit”. In FIG. 6, the portions which look dark (dark field portions) are pits.

In this embodiment, in an observation visual field 52 in which the image forming surface 41aa of the substrate 41 is observed in a visual field having an arbitrary size, the substrate 41 is required to meet a requirement that the total occupancy area ratio of pits having an area of 1 μm² or more with respect to an area of the observation visual field is 2% or more (this requirement will be referred to as “first requirement”) and a requirement that the average area per pit having an area of 1 μm² or more is greater than 8 μm² (this requirement will be referred to as “second requirement”).

By producing a photosensitive drum 47 using a substrate 41 meeting the first and second requirements, generation of interference patterns caused by multiple reflection of a laser beam emitted from an exposure source can be prevented, thereby making it possible to assuredly obtain a high-quality image. Therefore, for a substrate 41 formed from an uncut aluminum tube as an uncut metal tube, the first and second requirements are indexes for accurately judging the quality of image.

In the first requirement, it is especially preferred that the total occupancy area ratio of pits having an area of 1 μm² or more in the observation visual field area is 5% or more.

In the second requirement, it is especially preferred that the average area per pit having an area of 1 μm² or more is 10 μm² or more.

Furthermore, it is preferred that, in the observation visual field 52, the substrate 41 meets a requirement that the total occupancy area ratio of pits having an area of 1 μm² or more with respect to the observation visual field area is 15% or less (this requirement will be referred to as “third requirement”), a requirement that the average area per pit having an area of 1 μm² or more is 20 μm² or less (this requirement will be referred to as “fourth requirement”), and a requirement that there exist no large pits having an area of 300 μm² or greater (this requirement will be referred to as “fifth requirement”).

By producing a photosensitive drum 47 using a substrate 41 meeting all of the first to fifth requirements, generation of interference patterns due to multiple reflections of a laser beam can be prevented, and dark spots due to coating irregularities of the photoreceptor layer 45 can further be prevented from being formed on the printing surface. This makes it possible to assuredly obtain a high-quality image. Therefore, for a substrate formed from an uncut aluminum tube as an uncut metal tube, the first to fifth requirements are indexes for further accurately judging the quality of image.

The area of the observation visual field 52 (that is, the size of the observation visual field 52) can be set arbitrary, but is preferably set to 0.3 mm² to 1 mm². Furthermore, the shape of the observation visual field 52 can be set arbitrary, but it is especially preferably set to be approximately square or approximately circle.

The observation spots on the image forming surface 41aa can be set arbitrary. Furthermore, the number of observation spots is 1 or more, and is especially preferred to be plural in order to improve the accuracy of the index, normally 2 to 5.

In this embodiment, as shown in FIG. 1, an image of the image forming surface 41aa photographed by an imaging portion 51 provided in the image analysis device 50 is considered to be the observation visual field 52 and analyzed using the image analysis device 50 to thereby determine whether or not the aforementioned requirements are met.

The imaging portion 51 of the image analysis device 50 is provided with a CCD camera. Specifically, a digital microscope, etc., is used. The image analysis device 50 includes, a computer in which image analysis software for analyzing the image photographed by the imaging portion 51 is installed, a memory portion for storing the image (for example: a hard disk), a display portion for displaying the image (for example: liquid crystal display), etc.

It is preferable that the image analysis is performed based on a binarized image in which the image is binarized by a binarizing processing portion provided in the image analysis device 50.

Pits having an area of less than 1 μm² exert very little adverse effects on the image quality. Therefore, only pits having an area of 1 μm² or more are directed to the image analysis to perform judgments of each of the aforementioned requirements.

Furthermore, it is preferable that the substrate 41 is as straight as possible in the axial direction thereof. Specifically, it is preferable that, when a substrate 41, in which both end portions thereof are rotatably supported, is rotated about the axis of both end portions, the rotation deflection of the outer peripheral face of the axially intermediate portion of the substrate 41 in the radial direction is set to 15 μm or less (especially preferred to be 12 μm or less).

As shown in FIG. 2, the undercoat layer 42 is coated on the image forming surface 41aa of the substrate 41. The materials of the undercoat layer 42 is not limited and can be publically known materials, such as, specifically, e.g., polyvinyl alcohol, polyethylene oxide, ethyl cellulose, methyl cellulose, casein, polyamide, copolymer nylon, glue, gelatin, etc.

The thickness t1 of the undercoat layer 42 is not limited, but is preferably set to less than 20 μm. The reasons are as follows. That is, when the thickness t1 of the undercoat layer 42 is 20 μm or more, since the pits existing on the image forming surface 41aa will be covered by a thick undercoat layer 42, the difference in the thickness of the layers between the portion where pits exist and the portion where pits do not exist becomes relatively small, thereby making the differences in image quality caused by pits to become less visible. However, since the undercoat layer 42 absorbs moisture, there is a risk that the image quality may decline due to the change in environment. On the other hand, when the thickness t1 of the undercoat layer 42 is less than 20 μm, a high-quality image can be assuredly obtained.

The charge generating layer 43 is coated on the undercoat layer 42. The charge generation materials (CGM) included in the charge generating layer 43 are not limited and can be publically known materials. Specifically, for example, azo pigment, disazo pigment, quinone pigment, quinocyanine pigment, perylene pigment, indigo pigment, bisbenzimidazole pigment, phtalocyanine pigment, quinacridone pigment, pyrylium salt, azlenium salt, etc., can be used. The charge generating layer 43 is formed in a state in which these charge generation materials are dispersed in a binder resin. The binder resin is not limited and can be publically known binder resins. For example, phenoxy resin, epoxy resin, polyester resin, acrylic rein, polyvinyl butylal resin, polycarbonate resin, etc., can be used.

The charge transporting layer 44 is coated on the charge generating layer 43. The charge transporting material (CTM) contained in the charge transporting layer 44 is not limited and can be publically known materials. Specifically, for example, pyrazoline derivatives, oxazole derivatives, hydrazine derivatives, stilbene derivatives, etc., can be used. The charge transporting layer 44 is formed in a state in which these charge transporting materials are dispersed in the binder resin. The binder resin is not limited but can be publically known binder resin. Specifically, for example, polycarbonate resin, polyarylate resin, polymethyl methacrylate resin, polystyrene resin, polyester resin, phenoxy resin, epoxy resin, etc., can be used.

The thickness of the charge transporting layer 44 is not limited, but is in a range of, for example, 10 μm to 30 μm.

In the present invention, as shown in FIG. 3, it can be configured such that an undercoat layer is not disposed between the image forming surface 41aa of the substrate 41 and the photoreceptor layer 45, that is, the charge generating layer 43 of the photoreceptor layer 45 is directly formed on the image forming surface 41aa of the substrate 41.

Next, a preferred production method of the substrate 41 will be explained.

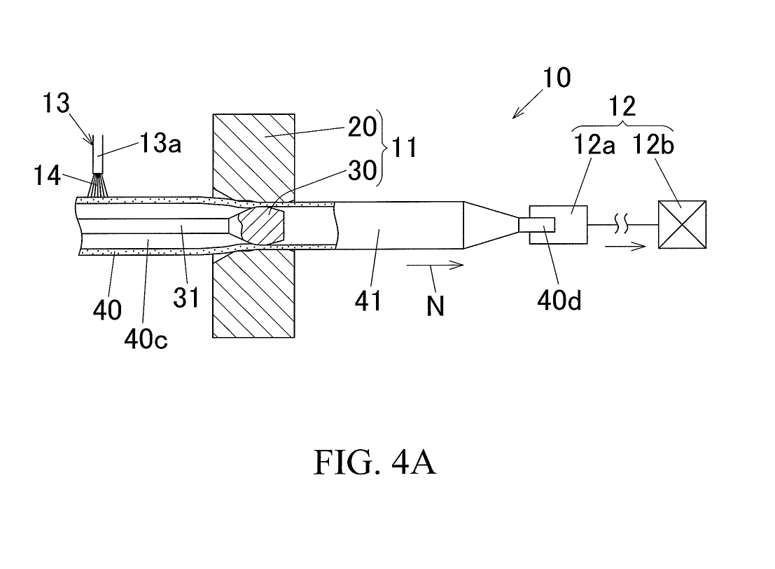

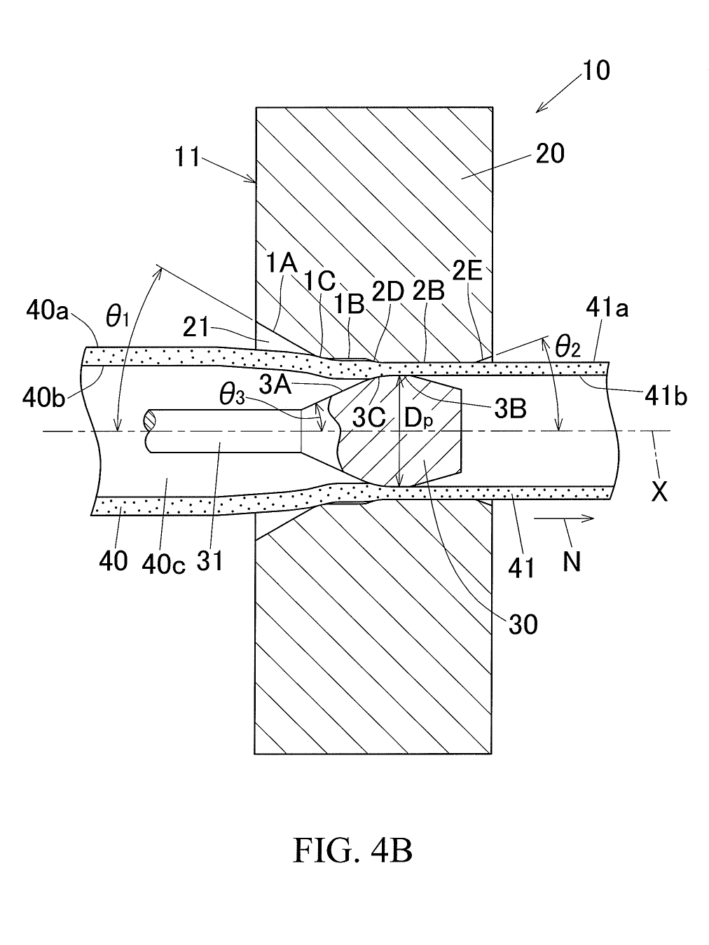

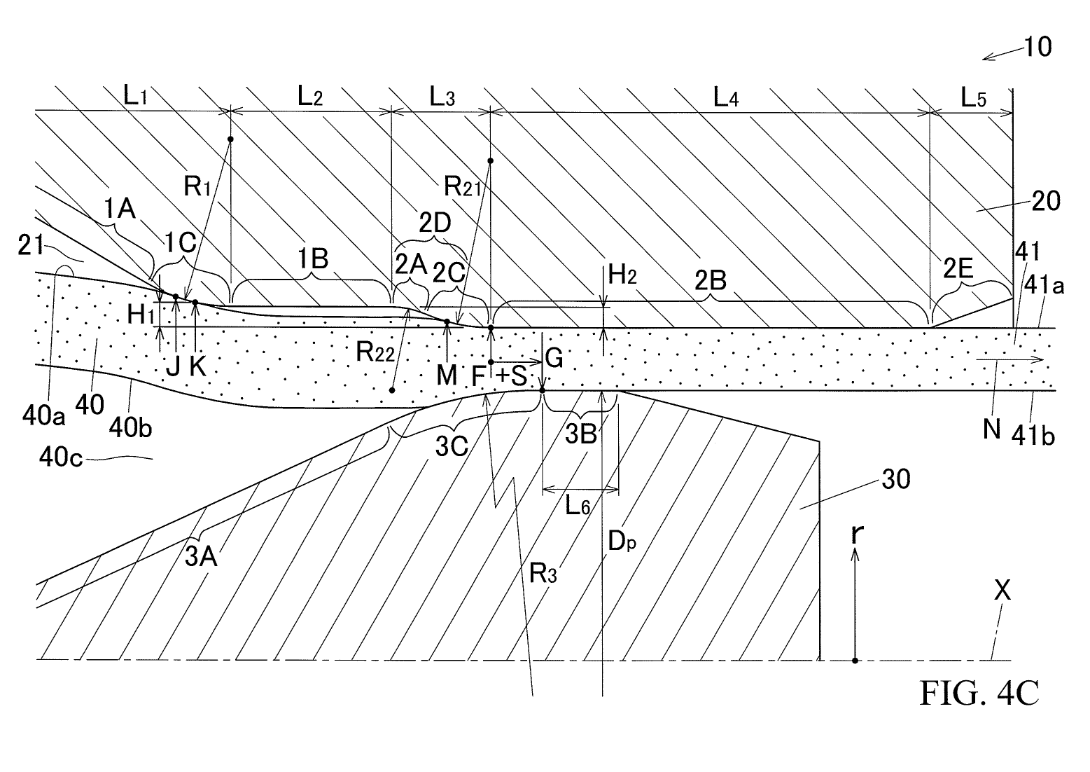

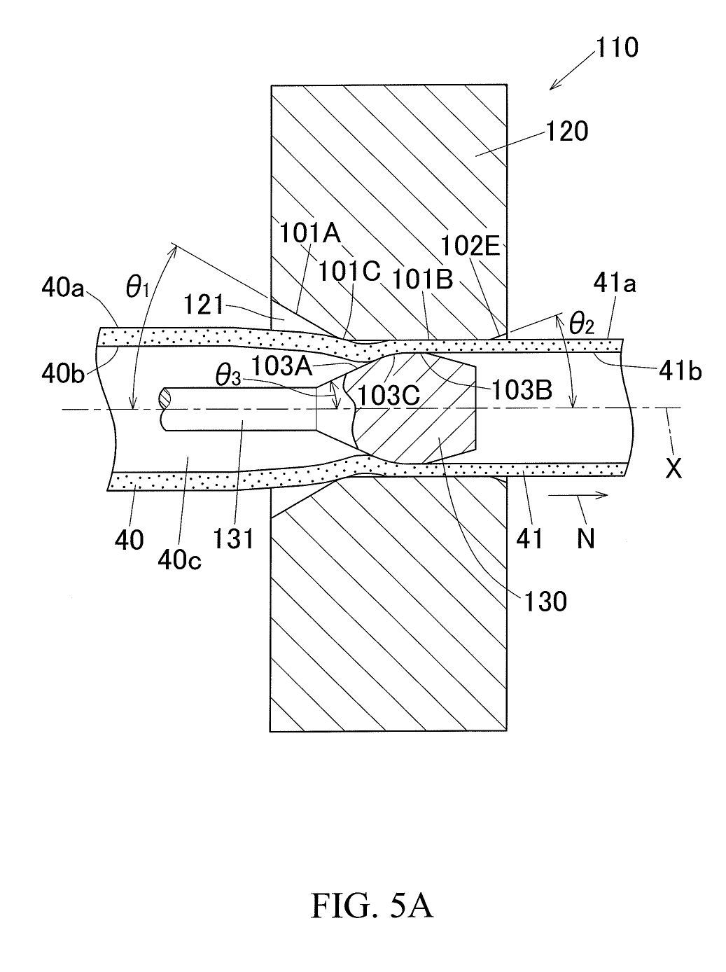

As described above, the substrate 41 is formed from a tube obtained by subjecting an extruded aluminum tube 40 as an extruded metal tube to a drawing process, i.e., an Extrusion-Drawing tube. In this drawing process, the drawing device for drawing the extruded aluminum tube 40 can be a publically known device, but it is especially preferable to use a device 10 having the structure as shown in FIGS. 4A to 4C.

As shown in FIG. 4A, the drawing device 10 employs a plug-drawing method instead of a non-plug-drawing method. Therefore, this drawing device 10 is equipped with a drawing tool 11 including the drawing die 20 and the drawing plug 30, and further includes a pulling device 12 and a lubricating oil supply device 13, etc.

In this drawing device 10, the extruded tube 40 is subjected to a drawing process so that the diameter reduction rate of the extruded tube 40 falls within a range of, e.g., 10% to 20%.

The diameter reduction rate Q of the extruded tube (specifically, the diameter reduction rate of the outer diameter of the extruded tube 40) is calculated by the following Formula (1), where the outer diameter of the extruded tube 40 before performing a drawing process is D0 and the outer diameter of the extruded tube 40 after performing a drawing process is D1.

Q={1−(D1/D0)}×100% Formula (1)

The drawing die 20 is for processing the outer surface 40a of the extruded tube 40, and is held by a die holder (not illustrated) in a fixed state. The material of the drawing die 20 is carbide, die steel, high speed tool steel, ceramics, etc. The specific structure of the drawing die 20 will be explained later.

The drawing plug 30 is disposed in a hollow portion 40c of the extruded tube 40 and is used for processing the inner surface 40b of the extruded tube 40, and is fixed to a tip portion of a supporting bar 31 supporting the drawing plug 30. The drawing plug 30 is an approximately round core type plug having a plug bearing portion 3B extending in a drawing direction N. The material for the drawing plug 30 is carbide, die steel, high speed tool steel, ceramics, etc. The specific structure of the drawing plug 30 will be explained below.

As shown in FIG. 4A, the pulling device 12 is for pulling the extruded tube 40 in a drawing direction N, and is equipped with a chuck portion 12a and a driving source 12b for applying a pulling force in the drawing direction N to the chuck portion 12a. The chuck portion 12a is for chucking a mouth portion 40d formed on a tip portion of the extruded tube 40. As the driving source 12b, an oil hydraulic cylinder, etc., can be used. In addition, the drawing direction N is a direction along the die axis X of the drawing die 20 (see FIG. 4B).

The lubricating oil supply device 13 is for supplying and applying lubricating oil 14 for a drawing process to the outer surface 40a of the extruded tube 40, and is equipped with a nozzle 13a for spraying the lubricating oil 14 toward the outer surface 40a of the extruded tube 40. The nozzle 13a is disposed on the upstream side of the drawing die 20.

The lubricating oil 14 is not limited, but it is especially preferable to use lubricating oil having kinematic viscosity of 200 m²/s to 800 mm²/s at 40° C.

The structure of the drawing die 20 is as follows.

The drawing die 20 is used in combination with the drawing plug 30 disposed inside a die hole 21 thereof, as shown in FIGS. 4B and 4C, and is equipped with a die approach portion 1A, a first curved surface portion 1C, a connecting portion 1B, a guiding portion 2D, a die bearing portion 2B, and a relief portion 2E. These portions (1A, 1C, 1B, 2D, 2B, 2E) are provided side-by-side in sequence in the drawing direction N on the peripheral surface of the die hole 21 of the drawing die 20. Furthermore, these portions are not separately divided but integrally formed. Also, all of the surfaces of these portions are polished into a mirror finished state.

The die approach portion 1A is formed so that the diameter thereof gradually decreases toward the downstream side of the drawing direction N. Specifically, it is formed into a tapered conical shape.

The angle of inclination of the die approach portion 1A with respect to the die axis X, that is, the half angle θ1 of the die approach (see FIG. 4B) is set to 5° to 40°, for example.

The first curved surface portion 1C is formed at the downstream end of the die approach portion 1A so as to be smoothly connected to the die approach portion 1A. That is, the first curved surface portion 1C is formed at and connected to the downstream end of the die approach portion 1A so that no step and/or angle is formed. Furthermore, the first curved surface portion 1C is formed so that the diameter thereof gradually decreases toward the downstream side of the drawing direction N. Also, in the cross-section including the die axis X of the drawing die 20, the inclination of the tangent line of the first curved surface portion 1C with respect to the die axis X gradually decrease as it advances in the drawing direction N. The longitudinal cross-section of the first curved surface portion 1C is arc-shaped. In this specification, the longitudinal cross-section denotes a cross-section including the die axis X of the drawing die 20, which is the cross-section as shown in FIGS. 4B and 4C.

The curvature radius R1 of the first curved surface portion 1C is set to 1 mm to 10 mm, for example.

The die approach portion 1A and the first curved surface portion 1C are portions where the extruded tube 40 is initially subjected to a diameter reducing process (specifically, a diameter reducing process of the outer surface 40a of the extruded tube 40). Furthermore, the first curved surface portion 1C is a portion from which the extruded tube 40 separates while being subjected to a diameter reducing process.

The length L1 in a direction parallel to the die axis X in which the die approach portion 1A and the first curved surface portion 1C are added is set to 10 mm to 50 mm, for example.

The position where the extruded tube 40 (specifically, the outer surface 40a of the extruded tube 40) initially comes into contact with the die approach portion 1A or the first curved surface portion 1C is called “J”. Also, the position where the extruded tube 40 separates from the first curved surface 1C while being subjected to a diameter reducing process is called “K”. In this embodiment, the extruded tube 40 initially comes in contact with not the die approach portion 1A but the first curved surface portion 1C. In the present invention, the extruded tube 40 can initially come into contact with the die approach portion 1A.

The die bearing portion 2B is disposed more inward (i.e., on the die axis X side) and on the downstream side than the extruded tube separating position K of the first curved surface portion 1C, and separately from the first curved surface portion 1C. The die bearing portion 2B is a portion for finishing the outer surface 40a and the outer diameter dimension of the extruded tube 40, and is formed so as to extend approximately parallel to the die axis X.

The length L4 of the die bearing portion 2B, specifically the length L4 of the die bearing portion 2B in a direction parallel to the die axis X, is set to 3 mm to 15 mm, for example, and is preferably set to 5 mm or longer. The length L4 of the die bearing portion is the length between the upstream end F and the downstream end of the die bearing portion 2B.

In the radial direction r of the drawing die 20, the step H1 between the extruded tube separating portion K on the first curved surface portion 1C and the die bearing portion 2B can be set variously but is preferably set to 0.3 mm or more but less than 3 mm.

The guiding portion 2D is a portion with which the extruded tube 40 (specifically, the outer surface 40a of the extruded tube 40) separated from the first curved surface portion 1C again comes into contact to guide the extruded tube 40 to the die bearing portion 2B while subjecting the tube 40 to a diameter reducing process. The guiding portion 2D is formed so that the diameter thereof gradually decreases toward the downstream side of the drawing direction N. The position at which the extruded tube 40 again comes in contact with the guiding portion 2D is called “M”.

The guiding portion 2D includes a second curved surface portion 2C having an arc-shaped longitudinal cross-section at the upstream end F of the die bearing portion 2B that is smoothly connected to the die bearing portion 2B, and further includes an auxiliary curved surface portion 2A having a reversed arc-shaped longitudinal cross-section at the upstream end of the second curved surface portion 2C that is smoothly connected to the second curved surface portion 2C.

In the cross-section including the die axis X of the drawing die 20, the inclination of the tangent line of the second curved surface portion 2C with respect to the die axis X gradually decreases as it advances in the drawing direction N. On the other hand, the auxiliary curved surface portion 2A curves in the opposite direction of the curving direction of the second curved surface portion 2C. That is, in the cross-section including the die axis X of the drawing die 20, the inclination of the tangent line of the auxiliary curved surface portion 2A with respect to the die axis X gradually increases as it advances in the drawing direction N.

The length L3 of the guiding portion 2D in a direction parallel to the die axis X is set to 2 mm to 5 mm, for example. The curvature radius R21 of the second curved surface portion 2C is set to 1 mm to 10 mm, for example. The curvature radius R22 of the auxiliary curved surface portion 2A is set to 1 mm to 10 mm, for example.

The connecting portion 1B is disposed between the first curved surface portion 1C and the guided portion 2D and is a portion for connecting the first curved surface portion 1C and the guiding portion 2D. In this embodiment, the connecting portion 1B integrally connects the first curved surface portion 1C and the guiding portion 2D. Therefore, the first curved surface portion 1C and the guiding portion 2D are integrally formed via the connecting portion 1B. Furthermore, the connecting portion 1B is formed approximately parallel to the die axis X so as not to come in contact with the extruded tube 40 at the time of the drawing processing. Furthermore, the upstream end of the connecting portion 1B is smoothly connected to the downstream end of the first curved surface portion 1C. Also, the downstream end of the connecting portion 1B is smoothly connected to the upstream end of the guiding portion 2D (specifically, the auxiliary curved surface portion 2A of the guiding portion 2D).

The length L2 of the connecting portion 1B in a direction parallel to the die axis X is set to 3 mm to 10 mm, for example.

In the radial direction r of the drawing die 20, the step H2 between the connecting portion 1B and the die bearing portion 2B is set equal to or slightly smaller than the aforementioned step H1 (that is, H2≦H1). The difference between H2 and H1 is generally very small. Therefore, H2 and H1 are different in a precise sense, but can generally be considered to be equal.

The relief portion 2E is a portion for forming an extruded tube outlet portion of the drawing die 20 and formed in such a manner that the diameter thereof gradually increases toward the downstream side of the drawing direction N so as not to come in contact with the extruded tube 40 (specifically, drawing tube). The inclination angle of the relief portion 2E with respect to the die axis X, that is, the escape half-angle θ2 of the relief portion 2E (see FIG. 4B) is set to 10° to 40°, for example. Therefore, the relief portion 2E is connected to the downstream end of the die bearing portion 2B with the escape half-angle θ2.

The length L5 of the relief portion 2E in the direction parallel to the die axis X is set to 2 mm to 10 mm, for example.

The structure of the drawing plug 30 is as follows.

The drawing plug 30 is disposed such that the axis thereof matches the die axis X of the drawing die 20, and is equipped with a plug approach portion 3A, a third curved surface portion 3C, and a plug bearing portion 3B. These portions (3A, 3C, 3B) are provided side-by-side sequentially in the drawing direction N on the peripheral surface of the drawing plug 30. Furthermore, these portions are integrally formed, rather than being individually separated. All of the surfaces of these portions are polished into a mirror-finish state.

The plug bearing portion 3B is a portion for finishing the inner surface 40b and the inner dimension of the extruded tube 40 and disposed at a position corresponding to the die bearing portion 2B of the drawing die 20. Specifically, it is disposed facing the die bearing portion 2B and approximately parallel to the die axis X. Furthermore, the position of the upstream end G of the plug bearing portion 3B is the same position as or on the downstream side of the position of the upstream end F of the die bearing portion 2B in the drawing direction N. In FIG. 4C, S refers to an amount of deviation of the position of the upstream end G of the plug bearing portion 3B with respect to the position of the upstream end F of the die bearing portion 2B to the downstream side. Therefore, as shown in FIG. 4C, when the position of the upstream end G of the plug bearing portion 3B with respect to the position of the upstream end F of the die bearing portion 2B is deviated to the downstream side, the symbol for the amount of deviation S is “+(positive)”. On the other hand, when the position of the upstream end G of the plug bearing portion 3B is deviated to the upstream side, the symbol for the amount of deviation S is “− (negative)”. The amount of deviation S is set to a range of −5 mm to 5 mm, for example, and is preferably set to a range of −1 mm to 3 mm. It is extremely preferred to be set to 0 mm to 2 mm.

The length L6 of the plug bearing portion 3B, that is, the length L6 of the plug bearing portion 3B in the direction parallel to the die axis X, is set be shorter than the length L4 of the die bearing portion 2B (that is, L6<L4). Furthermore, it is preferable that the length L6 is set to a range of 5% to 70% with respect to the length L4 of the die bearing portion 2B. It is especially preferred to be set in a range of 6% to 30%. In addition, Dp denotes a diameter of the plug bearing portion 3B of the drawing plug 30.

The plug approach portion 3A is formed so that the diameter thereof gradually increases toward the downstream side of the drawing direction N, that is, it is specifically formed into a tapered conical shape.

The inclination angle of the plug approach portion 3A with respect to the die axis X, that is, the plug approach half-angle θ3, is set to 5° to 20°, for example (see FIG. 4B).

The third curved surface portion 3C is disposed between the plug approach portion 3A and the plug bearing portion 3B and smoothly connects the plug approach portion 3A and the plug bearing portion 3B. That is, the third curved surface portion 3C is formed on the upstream end of the plug bearing portion 3B so as to be smoothly connected to the plug bearing portion 3B. Furthermore, the plug approach portion 3A is formed so as to be smoothly connected to the upstream end of the third curved surface portion 3C. In the cross-section including the die axis X of the drawing plug 30, the inclination of the tangent line of the third curved surface portion 3C with respect to the die axis X decreases gradually as it advances in the drawing direction N. Specifically, the longitudinal cross-sectional shape of the third curved surface portion 3C is an arc-shape.

The curvature radius R3 of the third curved surface portion 3C is set to 10 mm to 60 mm, for example.

The plug approach portion 3A and the third curved surface portion 3C are portions that come in contact with the extruded tube 40 (specifically, the inner surface 40b of the extruded tube 40) and guides the extruded tube 40 from the third curved surface portion 3C to the plug bearing portion 3B while subjecting the extruded tube 40 to a thickness reducing process. In this embodiment, the inner surface 40b of the extruded tube 40 initially comes in contact with the third curved surface portion 3C instead of the plug approach portion 3A. In the present invention, the inner surface 40b of the extruded tube 40 can initially come in contact with the plug approach portion 3A.

The method for subjecting the extruded tube 40 to a drawing process using the aforementioned drawing device 10, that is, the drawing process step, is approximately the same as a conventional method, and will be briefly explained as follows.

First, a mouth portion 40d having a smaller diameter than the extruded tube 40 is formed on the front end portion of the extruded tube 40 by a swaging process. Then, a drawing plug 30 is inserted and disposed in a hollow portion 40c of the extruded tube 40, and the front end portion of the extruded tube 40 (that is, mouth portion 40d) is inserted in the die hole 21 of the drawing die 20. At this time, the plug bearing portion 3B of the drawing plug 30 is disposed at a position corresponding to the die bearing portion 2B of the drawing die 20.

Next, the mouth portion 40d of the extruded tube 40 is chucked by the chuck portion 12a of the pulling device 12. Then, as shown in FIG. 4, the extruded tube 40 is pulled in the drawing direction N by the pulling device 12 so that the drawing speed is in a predetermined range (preferably 10 m/min to 100 m/min) while supplying the lubricating oil 14 from the nozzle 13a of the lubricating oil supply device 13 onto the outer surface 40a of the extruded tube 40. With this, the extruded tube 40 is subjected to a drawing process.

In this drawing process, as shown in FIGS. 4B and 4C, the extruded tube 40 comes into contact with the first curved surface portion 1C of the drawing die 20 and separates from the first curved surface portion 1C so as to be guided toward the guiding portion 2D while being subjected to a diameter reducing process by the first curved surface portion 1C. Next, the extruded tube 40 again comes into contact with the guiding portion 2D of the drawing die 20 and is guided to the die bearing portion 2B through the second curved surface portion 2C from the guiding portion 2D while being subjected to a diameter reducing process by the guiding portion 2D. At this time, the inner surface 40b of the extruded tube 40 comes into contact with the third curved surface portion 3C of the drawing plug 30 and is guided to the plug bearing portion 3B from the third curved surface portion 3C.

Then, since the extruded tube 40 passes through between the die bearing portion 2B and the plug bearing portion 3B, the outer surface 40a and the inner surface 40b of the extruded tube 40 are pressurized by the die bearing portion 2B and the plug bearing portion 3B, respectively, so that the thickness of the extruded tube 40 is reduced. As a result, the outer diameter dimension of the extruded tube 40 is finished into a targeted dimension by the die bearing portion 2B at the same that the outer surface 40a of the extruded tube 40 is finished into a highly smooth surface by the die bearing portion 2B. Furthermore, the inner diameter dimension of the extruded tube 40 is finished into a targeted dimension by the plug bearing portion 3B at the same time that the inner surface 40b of the extruded tube 40 is finished into a targeted surface roughness by the plug bearing portion 3B.

An Extrusion-Drawing tube having a moderately high smooth outer surface 41a can be obtained by the aforementioned drawing steps. Next, by subjecting the Extrusion-Drawing tube to cutting into a predetermined length, chamfering of the cut edge portions, and cleaning in order, a substrate 41 can be obtained.

Next, it is examined whether or not the image forming surface 41aa of the outer surface 41a of the obtained substrate 41 meets the aforementioned predetermined requirements (at least the first and second requirements among the first to fifth requirements). This step is called an inspection step. Then, a substrate 41 meeting the aforementioned predetermined requirements is used as a substrate for a photosensitive drum.

That is, a plurality of substrates 41 formed from the Extrusion-Drawing tube obtained by subjecting an extruded tube 40 to a drawing process using the aforementioned drawing device 10 include substrates in which the image forming surface 41aa of the outer surface 41a do not meet the aforementioned predetermined requirements. Accordingly, substrates having an image forming surface 41aa of the outer surface 41a which meets the aforementioned predetermined requirements are selected among the plurality of substrates obtained in the aforementioned manner. Then, a photosensitive drum 47 is produced using the selected substrate 41. Thus, a high-quality image can be assuredly obtained.

Therefore, it is especially preferable that the production method of a substrate for a photosensitive drum includes a drawing process step using the aforementioned drawing device 10 and an inspection step of inspecting whether or not the image forming surface 41aa of the outer surface 41a of the substrate 41 formed from the uncut aluminum tube (Extrusion-Drawing tube) obtained in the drawing process step meets the aforementioned predetermined requirements (at least the first and second requirements among the first to fifth requirements).

Thus, when the extruded tube 40 is subjected to a drawing process using the aforementioned drawing device 10, there are the following advantages.

In the drawing device 10, since the die bearing portion 2B of the drawing die 20 is disposed more radially inward than the extruded tube separating position K on the first curved surface portion 1C, the diameter of the extruded tube 40 can be prevented from being excessively reduced while the extruded tube 40 moves to the die bearing portion 2B from the first curved surface portion 1C. Therefore, acute irregularities allowing accumulation of the lubricating oil 14 are not formed on the outer surface 40a of the extruded tube 40 [Effect 1].

Furthermore, since the second curved surface portion 2C of the guiding portion 2D is smoothly connected to the upstream end F of the die bearing portion 2B, the extruded tube 40 which again came in contact with the guiding portion 2D can smoothly move toward the die bearing portion 2B through the second curved surface portion 2C [Effect 2].

Furthermore, since the length L6 of the plug bearing portion 3B of the drawing plug 30 is set to be shorter than the length L4 of the die bearing portion 2B, a pressure required to process the outer surface 40a of the extruded tube 40 into an appropriately high smooth surface can be assuredly applied to the extruded tube 40 from both the plug bearing portion 3B and the die bearing portion 2B [Effect 3].

When the aforementioned effects are exerted synergistically, the outer surface 40a of the extruded tube can be assuredly processed into an appropriately high smooth surface. With this, a desired substrate 41 can be obtained at a high yielding rate.

Furthermore, the position of the upstream end G of the plug bearing portion 3B of the drawing plug 30 is located at the same position or on the downstream side with respect to the position of the upstream end F of the die bearing portion 2B. Therefore, the extruded tube 40 which again came into contact with the guiding portion 2D of the drawing die can be assuredly prevented from being subjected to an excessive diameter reducing process while the extruded tube moves to the die bearing portion 2B from the guiding portion 2D. In addition, a pressure required for processing the outer surface 40a of the extruded tube 40 into an appropriately high smooth surface can be further assuredly applied from both the plug bearing portion 3B and the die bearing portion 2B. Consequently, the outer surface 40a of the extruded tube 40 can be further assuredly processed into a moderately high smooth surface.

Furthermore, in the cross-section including the die axis X of the drawing die 20, the inclination of the tangent line of the first curved surface portion 1C and the inclination of the tangent line of the second curved surface portion 2C with respect to the die axis X of the drawing die gradually decreases as it advances in the drawing direction N. Therefore, the diameter of the extruded tube 40 can be assuredly reduced by the first curved surface portion 1C, and the extruded tube 40 that again came into contact with the guiding portion 2D can be assuredly guided to the die bearing portion 2B by the second curved surface portion 2C.

Furthermore, the curvature radius R21 of the second curved surface portion 2C of the drawing die 20 is set to be equal to or smaller than the curvature radius R1 of the first curved surface portion 1C. Accordingly, the outer surface 40a of the extruded tube 40 can be further assuredly processed into a high smooth surface. The reasons are as follows. That is, by setting the curvature radius R1 of the first curved surface portion 1C large, the drawn-in amount of the lubricating oil 14 drawn in between the outer surface 40a of the extruded tube 40 and the drawing die 20 can be sufficiently secured. Furthermore, by setting the curvature radius R21 of the second curved surface portion 2C small, the surface pressure applied to the outer surface 40a of the extruded tube 40 from the second curved surface portion 2C can be increased. Thus, possible generation of oil pits can be further controlled. As a result, the outer surface 40a of the extruded tube 40 can be further assuredly processed into a moderately high smooth surface.

Furthermore, since the guiding portion 2D includes an auxiliary curved surface portion 2A smoothly connected to the upstream end of the second curved surface portion 2C and curved in a direction opposite to the curved direction of the second curved surface portion 2C, the extruded tube 40 separated from the first curved surface portion 1C can be assuredly received by the guiding portion 2D. This in turn can assuredly guide the extruded tube 40 to the die bearing portion 2B from the guiding portion 2D.

Furthermore, since the length L6 of the plug bearing portion 3B of the drawing plug 30 is set to 5% or more with respect to the length L4 of the die bearing portion 2B, a pressure required to process the outer surface 40a of the extruded tube 40 into a moderately high smooth surface can be further assuredly applied from both the plug bearing portion 3B and the die bearing portion 2B. With this, the outer surface 40a of the extruded tube 40 can be further assuredly processed into a moderately high smooth surface. Also, since the length L6 of the plug bearing portion 3B is set to 70% or less with respect to the length L4 of the die bearing portion 2B, breakage of the extruded tube 40 caused by contact friction between the extruded tube 40 and the plug bearing portion 3B can be assuredly prevented.

Furthermore, by setting the length L4 of the die bearing portion 2B of the drawing die 20 to 5 mm or longer, the outer surface 40a of the extruded tube 40 can be further assuredly processed into a moderately high smooth surface.

Furthermore, in the radial direction r of the drawing die 20, since the step H1 between the extruded tube separating position K of the first curved surface portion 1C of the drawing die 20 and the die bearing portion 2B is set to 0.3 mm or more, the diameter of the extruded tube 40 can be assuredly prevented from being excessively reduced while the extruded tube 40 moves from the first curved surface portion 1C to the die bearing portion 2B. Also, since the step is set to less than 3 mm, the extruded tube 40 can be assuredly prevented from separating from the die bearing portion 2B when the extruded tube 40 which again came into contact with the guiding portion 2D is guided to the die bearing portion 2B. Thus, the outer surface 40a of the extruded tube 40 can be further assuredly processed into a moderately high smooth surface.

Furthermore, since the first curved surface portion 1C, the die bearing portion 2B, and the guiding portion 2D of the drawing die 20 are integrally formed, misalignment between the axis of the first curved surface portion 1C and the axis of the die bearing portion 2B can be prevented. Thus, the coaxiality of the drawing die 20 is improved. Therefore, by subjecting the extruded tube 40 to a drawing process using the drawing die 20, the dimensional accuracy of the outer diameter and the inner diameter of the substrate 41 can be assuredly improved.

Furthermore, since the drawing plug 30 is equipped with a third curved surface portion 3C smoothly connected to the upstream end G of the plug bearing portion 3B, the extruded tube 40 in contact with the third curved surface portion 3C can smoothly move toward the plug bearing portion 3B. Therefore, the outer surface 40a of the extruded tube 40 can be further assuredly processed into a moderately high smooth surface.

Although an embodiment of the present invention was explained above, the present invention is not limited to that.

In the present invention, it is especially preferable that the drawing device for drawing the extruded tube is the device 10 having the structure as described in the aforementioned embodiment, but the present invention is not limited to that, and no other drawing devices (for example: conical die) are excluded.

### EXAMPLES

Next, specific Examples and Comparative Examples of the present invention will be explained. It should be, however, noted that the present invention is not specifically limited to the following Examples. In the following explanation, the same symbols as those in the aforementioned embodiment are used for an easy understanding of Examples and Comparative Examples.

TABLE 1

| | | | | Total | | | | |
|---|---|---|---|---|---|---|---|---|
| | | | | Occupancy | | Number of Rough | | |
| | | | | Area Ratio | | Large Pits Having | Evaluation of Image | |
| | | | | of Pits | Average | Area of 300 μm² or | Quality | |
| | | | Kinematic | Having | Area Per Pit | more/Maximum Pit | Interference | |
| | Type of | Type of | Viscosity of | Area of 1 μm² | Having Area | Area | Pattern | Incidences |
| | Extruded | Drawing | Lubricating | or | of 1 μm² or | (Number/Maximum | Incidence | of Dark |
| | Tube | Device | Oil (mm²/s) | more (%) | more (μm²) | Pit Area μm²) | Rate | Spots |
| Comparative | B | “10” | 200 | 2 | 8 | 0/120 | X | ◯ |
| Example 1 | | | | | | | | |
| Comparative | B | “10” | 200 | 2 | 10 | 0/150 | X | ◯ |
| Example 2 | | | | | | | | |
| Comparative | B | “10” | 200 | 4 | 7 | 0/200 | X | ◯ |
| Example 3 | | | | | | | | |
| Example 1 | B | “10” | 200 | 3 | 10 | 0/230 | ◯ | ◯ |
| Example 2 | A | “10” | 200 | 5 | 13 | 0/280 | ◯ | ◯ |
| Example 3 | B | “10” | 400 | 10 | 12 | 0/120 | ◯ | ◯ |
| Example 4 | A | “10” | 400 | 12 | 14 | 0/250 | ◯ | ◯ |
| Example 5 | A | “10” | 400 | 15 | 18 | 0/200 | ◯ | ◯ |
| Example 6 | A | “10” | 800 | 13 | 15 | 0/250 | ◯ | ◯ |
| Example 7 | A | “10” | 800 | 13 | 16 | 0/200 | ◯ | ◯ |
| Example 8 | B | “110” | 200 | 16 | 20 | 0/250 | ◯ | X |
| Example 9 | B | “110” | 800 | 9 | 21 | 11/550 | ◯ | X |
| Example 10 | A | “110” | 200 | 8 | 15 | 1/350 | ◯ | X |
| Example 11 | A | “110” | 400 | 16 | 28 | 38/2550 | ◯ | X |
| Example 12 | A | “110” | 800 | 20 | 53 | 67/3650 | ◯ | X |
| Example 13 | A | “110” | 800 | 24 | 56 | 94/4150 | ◯ | X |

### Examples 1 to 13, Comparative Examples 1 to 3

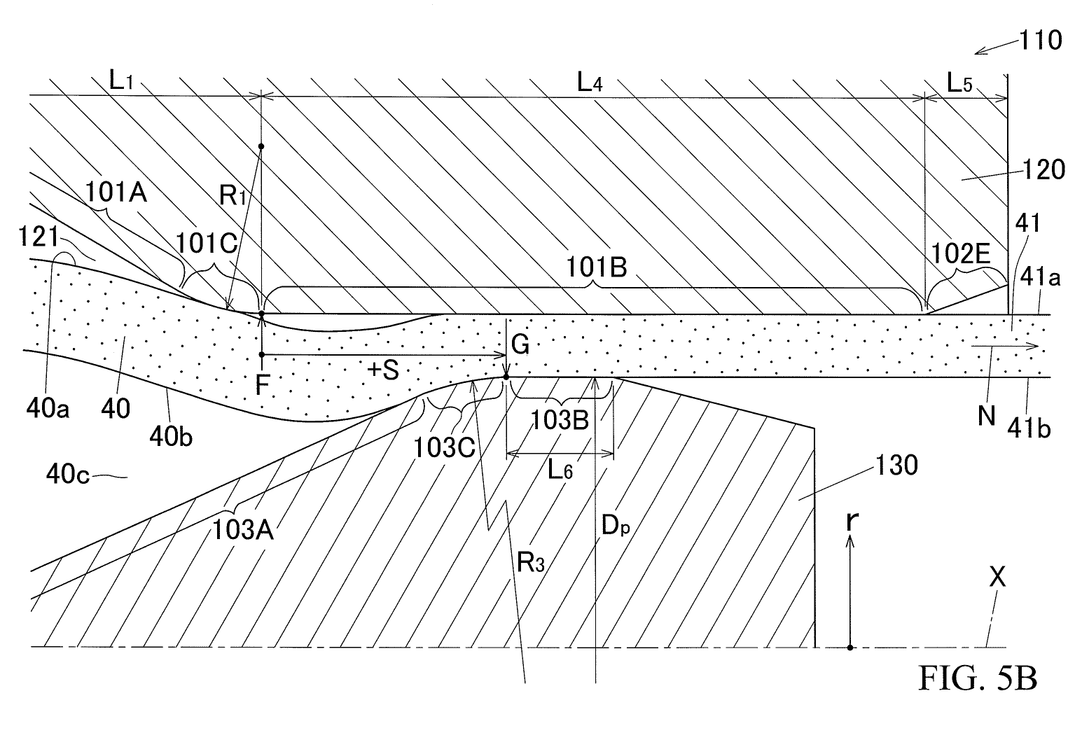

In Examples 1 to 7 and Comparative Examples 1 to 3, using the drawing device 10 of the aforementioned embodiment as shown in FIGS. 4A to 4C, and in Examples 8 to 13, using the drawing device 110 of the drawing device as shown in FIGS. 5A and 5B, an extruded aluminum tube 40 was subjected to a drawing process once to thereby obtain an Extrusion-Drawing tube as an uncut aluminum tube. Then, a substrate for a photosensitive drum 41 was obtained by sequentially subjecting the Extrusion-Drawing tube to cutting into a predetermined length, chamfering of the cut edge portions, and cleaning in order. The length of the substrate 41 was 260 mm.

Next, as shown in FIG. 1, the image forming surface 41aa of the outer surface 41a of the substrate 41 was evaluated.

Next, as shown in FIG. 2, a photosensitive drum 47 was produced by coating a separated-function type organic photoreceptor layer 45 (that is, a charge generating layer 43 and a charge transporting layer 44) on the image forming surface 41aa of the substrate 41 via the undercoat layer 42. Then, using the photosensitive drum 47, actual printing was performed, and the existence of incidence rate of interference patterns and incidence of dark spots were examined as an evaluation of the image quality.

[Drawing Process Conditions]

In Examples 1 to 7 and Comparative Examples 1 to 3, the drawing process conditions for the extruded aluminum tube 40 were as follows.

The material for the extruded aluminum tube 40 was an aluminum alloy equivalent to A3003 frequently used as a substrate for a photosensitive drum. There were two sizes for the extruded tube 40 (A, B). The extruded tube 40 of type A had an outer diameter of 28 mm, an inner diameter of 25.6 mm and a thickness of 1.2 mm. The extruded tube of type B had an outer diameter of 27 mm, an inner diameter of 24.5 mm, and a thickness of 1.25 mm. In the column of “Type of Extruded Tube” in Table 1, the type of extruded tube 40 used in each Example and Comparative Example is noted. The Extrusion-Drawing tubes obtained by subjecting each extruded tube 40 to a drawing process had an outer diameters of 24 mm, an inner diameter of 22.6 mm, and a thicknesses of 0.7 mm. The lubricating oil 14 used at the time of drawing had a kinematic viscosity at 40° C. as recited in the column “Kinematic Viscosity of Lubricating Oil” in Table 1. The amount of supplying the lubricating oil 14 to the extruded tube 40 was 1,000 g/min. The drawing rate was 20 m/min.

[Drawing Process Device]

The dimension of each portion of the drawing device 10 of the aforementioned embodiment used in Examples 1 to 7 and Comparative Examples 1 to 3 was as follows. In Examples 1 to 7 and Comparative Examples 1 to 3, a symbol “10” meaning the drawing device 10 of the aforementioned embodiment is used in the column “Type of Drawing Device” in Table 1.

In the drawing die 20, θ1=25°, θ2=15°, L1=10 mm, L2=5 mm, L3=4 mm, L4=9 mm, L5=2 mm, R1=10 mm, R21=2 mm, R22=4 mm, H2=0.5 mm.

In the drawing plug 30, θ3=20°, L6=1 mm, R3=50 mm, S=1 mm, Dp=22.6 mm.

The drawing device 110 used in Examples 8 to 13 was equipped with a superhard conical die as shown in FIGS. 5A and 5B, and the structure was as follows. In Examples 8 to 13, a symbol “110” meaning the drawing device 100 as shown in FIGS. 5A and 5B is used in the column “Type of Drawing Device” in Table 1.

In the drawing die 120 of the drawing device 110, a die approach portion 101A was formed on the periphery of the die hole 121 and a curved surface portion 101C having an arc-shaped longitudinal cross-section was smoothly connected and formed at the downstream end of the die approach portion 101A. Further, the curved surface portion 101C was smoothly connected and formed at the upstream end F of the die bearing portion 101B. That is, the die approach portion 101A and the die bearing portion 101B were smoothly connected with each other via the curved surface portion 101C. A relief portion 102E was formed at the downstream end of the die bearing portion 101B. The die bearing portion 101B was formed approximately parallel to the die axis X. θ1 denotes a die approach half-angle. θ2 denotes an escape half-angle of the relief portion 102E. L1 denotes a length in a direction parallel to the die axis X, wherein the length is a total length of the die approach portion 101A and the curved surface portion 101C. L4 denotes a length of the die bearing portion 101B. L5 denotes a length of the relief portion 102E in a direction parallel to the die axis X. R1 denotes a curvature radius of the curved surface portion 101C.

The drawing plug 130 of the drawing device 110 is approximately a round core type plug provided at the front end portion of the supporting bar 131 supporting the drawing plug 130, and disposed inside a hollow portion 40c of the extruded tube 40. A plug approach portion 103A, a curved surface portion 103C, and a plug bearing portion 103B are formed on the peripheral surface of the drawing plug 130. The plug bearing portion 103B was formed approximately parallel to the die axis X and disposed so as to face the die bearing portion 101B. The curved surface portion 103C was smoothly connected to and formed at the upstream end G of the plug bearing portion 103B, and the curved surface portion 103C was smoothly connected to and formed at the downstream end of the plug approach portion 103A. That is, the plug approach portion 103A and the plug bearing portion 103B were smoothly connected to each other via the curved surface portion 103C. θ3 denotes a plug approach half-angle. L6 denotes a length of the plug bearing portion 103B. R3 denotes a curvature radius of the curved surface portion 103C. S denotes an amount of deviation of the position of the upstream end G of the plug bearing portion 103B on the downstream side with respect to the position of the upstream end F of the die bearing portion 101B. The length L6 of the plug bearing portion 103B is set to be shorter than the length L4 of the die bearing portion 101B. Dp denotes a diameter of the plug bearing portion 103B of the drawing plug 130.

As shown in FIG. 5B, when an extruded tube is subjected to a drawing process using the drawing device 110, when the extruded tube 40 is guided to the die bearing portion 101B from the curved surface portion 101C, the extruded tube 40 once separates from the curved surface portion 101C and contacts the die bearing portion 101B again. Therefore, when the extruded tube 40 moves to the die bearing portion 101B from the curved surface portion 101C, the diameter of the extruded tube 40 is excessively reduced. Thus, the outer surface 40a of the extruded tube 40 gets dented in an arc-shaped longitudinal cross-sectional shape and a number of sharp minute irregularities (not illustrated) are formed on the outer surface 40a. The lubricating oil for the drawing process accumulates in these sharp minute irregularities. When the extruded tube 40 passes through between the die bearing portion 101B and the plug bearing portion 103B in this state, a pressure is applied to the outer surface 40a of the extruded tube 40. As a result, minute oil pits are more formed on the outer surface of the obtained Extrusion-Drawing tube than the Extrusion-Drawing tube obtained by the drawing device 10 of the aforementioned embodiment.

In the drawing die 120, θ=25°, θ2=15°, L1=10 mm, L4=20 mm, L5=2 mm, R1=10 mm.

In the drawing plug 130, θ3=20°, L6=1 mm, R3=50 mm, S=7 mm, Dp=22.6 mm.

[Evaluation Method of Image Forming Surface 41aa (Inspection Method)]

The evaluation method (inspection method) of the image forming surface 41aa of the substrate 41 was as follows.

The image forming surface 41aa of the substrate 41 was observed at two spots by a digital microscope, which is an imaging portion 51 of the image analysis device 50, with a visual field of a 0.6 mm² size to take each of the images of the observation visual fields 52. Then, the image forming surface 41aa was evaluated by analyzing the two images taken using the image analysis device 50. The image analysis was performed based on a black and white binarized image in which an image is binary processed, using image analysis software preliminarily installed in the image analysis device 50. The binary process was performed after converting the taken image to a grayscale image of 256 gradations as brightness 130 as a threshold. That is, in this binary process, a range in which the brightness is 0 or more but up to 130 in the grayscale image of 256 gradations was defined as a dark field portion and a range in which the brightness exceeds 130 but up to 255 was defined as a light field portion, and the dark field portions were considered as pits. The evaluation items for the image forming surface 41aa were the total occupancy area rate of pits having an area of 1 μm² or more with respect to the area of the observation visual field, the average area per pit having an area of 1 μm² or more, the number of rough and large pits having an area of 300 μm² or more, the shape of pits, etc. The product name (model number) of the digital microscope used for the image analysis was “VHX-500” (distributor: KEYENCE), and the zoom lens installed on the digital microscope was “VH-Z100”. The magnification rate of the image taken by the digital microscope was 300 times. The image was captured by disposing the zoom lens above the apex of the image forming surface 41aa of the substrate 41 disposed horizontally. The form of illumination used for image capturing was coaxial episcopic illumination. Since it becomes difficult to recognize the irregularities at the time of the binary process when the image to be captured is too bright, the brightness of the illumination was set to 50%. Also, at the time of capturing the image, various types of filters were not used for the lens. Since a curved surface is captured with this imaging, when a rigorous image analysis is to be conducted, conventionally, it is required to correct the shading of the image so as to make the overall image even on average, etc. However, since the rate of image magnification was 300 times, which was a high magnification rate, the unevenness of the up and down brightness by the curved surface was considered to be able to be ignored, so corrections and image highlighting processes were not performed. The product name of the image analysis software was “WinROOF” (distributor: Mitani Shoji), and the image resolution at the time of image analysis was 0.63 μm/pixel. The minimum pit area that can be recognized by this image analysis software was 0.4 μm². As described above, pits having an area less than 1 μm² exert very little bad influence to image quality. Therefore, in this image analysis, analysis was directed only to pits having an area of 1 μm² or more. For pits extending over the outer peripheral boundaries of images, the areas of the portions of the pits existing inside the outer peripheral boundaries of the images were measured. When light field portions were scattered inside the pits, the entire inside of the pits were made into dark field portions by filling the inside of the pits with black at the time of the binary process, and the entire inside of the pits were considered as the area of the pits.

For Examples 1 to 13 and Comparative Examples 1 to 3, the surface roughness (maximum height) Ry of the image forming surface 41aa of the substrate 41 was measured by a stylus-type surface roughness tester compliant with a conventionally widely used JIS B 0601:1994. The results were as follows. The radius R of the tip of the probe of the surface roughness tester used for the measurement was 5 μm and the measured length was 4 mm.

Comparative Example 1: Ry=0.33 μm, Comparative Example 2: Ry=0.32 μm, Comparative Example 3: Ry=0.41 μm, Example 1: Ry=0.43 μm, Example 2: Ry=0.36 μm, Example 3: Ry=0.42 μm, Example 4: Ry=0.41 μm, Example 5: Ry=0.49 μm, Example 6: Ry=0.59 μm, Example 7: Ry=0.63 μm, Example 8: Ry=0.54 μm, Example 9: Ry=0.68 μm, Example 10: Ry=0.75 μm, Example 11: Ry=0.88 μm, Example 12: Ry=0.98 μm, Example 13: Ry=1.21 μm.

[Undercoat Layer 42]

The coating method for the undercoat layer 42 was as follows.

A coating liquid in which 10 mass parts of polyamide resin and 3 mass parts of methanol were mixed was coated on the image forming surface 41aa and then heated for 30 minutes at 80° C. to thereby form the undercoat layer 42. The thickness t1 of the undercoat layer 42 was 15 μm.

[Charge Generating Layer 43]

The coating method of the charge generating layer 43 was as follows.

The substrate 41 was immersed in a liquid in which a metal-free phthalocyanine pigment (charge generating material) was dispersed and diluted by tetrahydrofuran, then the substrate 41 was pulled out and dried afterward to thereby form the charge generating layer 43. The thickness t2 of the charge generating layer 43 was 0.5 μm.

[Charge Transport Layer 44]

The coating method for the charge transport layer 44 was as follows.

A coating liquid, in which hydrazine compound (charge transporting material) and polycarbonate resin (binder resin) were dissolved in methylene chloride, was coated on the charge generating layer 43 and then dried to thereby form the charge transport layer 44. The thickness of the charge transport layer 44 was about 20 μm.

[Evaluation Method of Image Quality]

The evaluation method of the image quality was as follows.

A midtone contact printed image by a dot pattern was printed on 20 pages of A4 papers (dimension: width 210 mm×length 297 mm) by a laser beam printer including the photosensitive drum 47. Then, the percentage of generation of interference patterns on one printed surface was examined. When the percentage was below 5%, “∘” was entered in the column “Interference Pattern Incidence Rate” and “x” was entered in the column when the percentage was 5% or more. The interference pattern is a pattern generated from multiple reflection of a laser beam on the interface in the photoconductor layer 45 and the outer surface 41a of the substrate 41. Furthermore, the number of minute black dots existing on one printed surface was visually examined. When the number of black dots was 2 or more, “x” was entered in the column “Incidences of Dark Spots” and when the number was below 2 (that is, 0 or 1), “∘” was entered in the column.

[Comprehensive Evaluation]

As shown in Table 1, generation of interference patterns could be prevented when both the requirements, i.e., the first requirement in which the total occupancy area rate of pits having an area of 1 μm² or more in an observation visual field area was 2% or more, and the second requirement in which the average area per pit having an area of 1 μm² or more was 8 μm² or more, were met (that is, Examples 1 to 13).

Furthermore, when the third requirement in which the total occupancy area rate of pits having an area of 1 μm² or more in an observation visual field area was 15% or less, the fourth requirement in which the average area per pit having an area of 1 μm² or more was 20 μm² or less, and the fifth requirement in which there were no rough and large pits having an area of 300 μm² or more, were all met (that is, Examples 1 to 7), generation of dark spots could be prevented.

Accordingly, for accurately judging the quality of the images of the substrate 41 formed from an uncut tube such as an Extrusion-Drawing tube, it was confirmed that these requirements were indexes better than the conventional index of surface roughness Ry.

The present invention claims priority to Japanese Patent Application No. 2011-179867 filed on Aug. 19, 2011, the entire disclosure of which is incorporated herein by reference in its entirety.

The terms and descriptions used herein are used only for explanatory purposes and the present invention is not limited to them. The present invention allows various design-changes falling within the claimed scope of the present invention unless it deviates from the spirits of the invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

### INDUSTRIAL APPLICABILITY

The present invention can be applicable to a substrate for a photosensitive drum for an electrophotographic device (such as a copying machine, a printer, and a facsimile device) and a production method for a substrate for a photosensitive drum.

### DESCRIPTION OF THE REFERENCE NUMERALS

10: drawing device
20: drawing die
1A: die approach portion
1B: connecting portion
1C: first curved surface portion
2A: auxiliary curved surface portion
2B: die bearing portion
2C: second curved surface portion
2D: guiding portion
2E: relief portion
30: drawing plug
3A: plug approach portion
3B: plug bearing portion
3C: third curved surface portion
X: die axis
N: drawing direction
40: extruded aluminum tube (extruded metal tube)
41: substrate
41a: outer surface
41aa: image forming surface
42: undercoat layer
43: charge generating layer
44: charge transport layer
45: organic photoreceptor layer
47: photosensitive drum
50: image analysis device
51: imaging portion
52: observation visual field

1. A substrate for a photosensitive drum formed from an uncut metal tube,
wherein, in an observation visual field in which an image forming surface is observed in a visual field having an arbitrary size, a total occupancy area ratio of pits having an area of 1 μm² or more with respect to an area of the observation visual field is 2% or more, and an average area per pit having an area of 1 μm² or more is greater than 8 μm².

2. The substrate for a photosensitive drum as recited in claim 1, wherein, in the observation visual field,
the total occupancy area ratio of pits having an area of 1 μm² or more with respect to the area of the observation visual field is 15% or less,
the average area per pit having an area of 1 μm² or more is 20 μm² or less, and
no large pits having an area of 300 μm² or more exist.

3. The substrate for a photosensitive drum as recited in claim 1, wherein the substrate is made of aluminum.

4. A production method of the substrate for a photosensitive drum as recited in claim 1, the method comprising:
a drawing process step of obtaining an uncut metal tube by subjecting an extruded metal tube to a drawing process using a drawing device equipped with a drawing die for processing an outer surface of the extruded metal tube and a drawing plug for processing an inner surface of the extruded metal tube,
wherein the drawing die includes
a first curved surface portion from which the extruded metal tube separates while being subjected to a diameter reducing process,
a die bearing portion arranged radially inward of and downstream of an extruded metal tube separating position on the first curved surface portion, and
a guiding portion having a second curved surface portion smoothly continued to an upstream end of the die bearing portion, the guiding portion being configured to guide the extruded metal tube to the die bearing portion while subjecting the extruded metal tube to a diameter reducing process by coming into re-contact with the extruded metal tube separated from the first curved surface portion, and
wherein the drawing plug is equipped with a plug bearing portion shorter than a length of the die bearing portion.
